(19) United States
(12) Patent Application Publication
(10) Pub. No.: US 2003/0189752 A1
(43) Pub. Date: Oct. 9, 2003

(54) Portable optical device

(75) Inventors: Ken Hirunuma, Tokyo (JP); Masami Shirai, Saitama (JP); Gouji Funatsu, Saitama (JP); Keiichi Hotta, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/400,807

(22) Filed: Mar. 28, 2003

(30) Foreign Application Priority Data
Apr. 4, 2002 (JP) P2002-102396

(51) Int. Cl. G02B 23/00

(52) U.S. Cl. 359/409; 359/399; 359/407; 359/408; 359/819

(57) ABSTRACT

A portable optical device comprises an optical-system mount plate, a control circuit board, and an inner frame. The inner frame has first pillar elements, and second pillar elements. The first pillar elements are provided for supporting the optical-system mount plate. The second pillar elements are provided for supporting the control circuit board. The first and second pillar elements are constructed in such a manner that the optical-system mount plate is disposed between the inner frame and the control circuit board.

### BACKGROUND OF THE INVENTION

1. Field of the Invention

The present invention relates to a portable optical device having a control circuit board.

2. Description of the Related Art

As examples of the portable optical devices, there are digital cameras, video cameras, monoculars and binoculars having an auto-focusing mechanism, each of which is provided with a solid-state imaging device.

An inner frame, an electronic circuit board, and other various kinds of parts or units, are housed in a casing of an optical device, and a part or unit, to which another part or unit is attached, is attached or anchored to the inner frame. Thus, complex arrangements of parts or units create attaching errors, so that not only does the attaching accuracy of the parts and units become low, but also the strength of the whole structure can be lowered.

The reason why one part or unit has to be attached to another part or unit is to reduce the effects of positional errors. Parts having a relatively large size such as an optical-system mount plate for a photographing optical system, or a control circuit board, are typically attached to the inner frame. If the attaching positions of the large size parts have errors, these errors will be translated to all other parts or units connected to both the large-size parts and units and the inner frame. Thus, it would become difficult or impossible for the other parts or units to be aligned with and directly attached to the inner frame.

Especially, in a slide-type binocular telescope in which the casing can be slidably moved for adjusting the interpupillary distance, since an optical-system mount plate, on which a pair of telescopic optical systems is mounted, has two slide plates movable relative to each other, the structure of the optical-system mount plate is complex. Therefore, for directly attaching as many parts or units on the inner frame as possible, the position at which the optical-system mount plate is to be attached to the inner frame has to be considered carefully in connection with the position at which the control circuit board is attached.

### SUMMARY OF THE INVENTION

Therefore, an object of the present invention is to provide an optical device in which the positions at which the optical-system mount plate and the control circuit board are attached to the inner frame are improved so that as many parts or units as possible can be directly attached to the inner frame.

According to the present invention, there is provided a portable optical device comprising an optical-system mount plate, a control circuit board, and an inner frame. The inner frame has a first support mechanism for supporting the optical-system mount plate, and a second support mechanism for supporting the control circuit board, the first and second support mechanisms being constructed in such a manner that the optical-system mount plate is disposed between the inner frame and the control circuit board.

The first support mechanism may have first pillar elements that are formed on the inner frame and extend in the thickness direction of the optical-system mount plate and the control circuit board, and the second support mechanism may have second pillar elements that are formed on the inner frame and extend in the thickness direction of the optical-system mount plate and the control circuit board. In this case, the first pillar elements are formed with first screw holes, the optical-system mount plate is formed with first insert holes corresponding to the first screw holes, end portions of the second pillar elements, in which second screw holes are formed, abut on the control circuit board which is positioned opposite to the inner frame with respect to the optical-system mount plate, the control circuit board is formed with second insert holes corresponding to the second screw holes, and first screws are inserted in the first insert holes and threaded in the first screw holes, and second screws are inserted in the second insert holes and threaded in the second screw holes, so that the optical-system mount plate and the control circuit board are connected to the inner frame so as to be parallel to each other.

Preferably, the inner frame has a central portion, a wing portion extending from the central portion along the optical-system mount plate, and a vertical wall extending from a periphery of the wing portion so that the vertical wall is substantially perpendicular to the wing portion. The first pillar elements extend from the central portion, at least one of the second pillar elements extends from the central portion, and the other of the second pillar elements extend from the vertical wall.

The second pillar elements can be provided outside the optical-system mount plate. The at least one of the second pillar elements may penetrate through the optical-system mount plate.

Optionally, the portable optical device further comprises a pair of telescopic optical systems that is mounted on the optical-system mount plate, so that the device functions as binoculars.

In this case, preferably, the optical-system mount plate has two plate members, one of the telescopic optical systems being mounted on one of the plate members while another of the telescopic optical systems is mounted on another of the plate members, the plate members being moved relative to each other so that a distance between the optical axes of the telescopic optical systems is adjustable. Further, a part of each of the telescopic optical systems may be movable relative to the other part of each of the telescopic optical systems, so that a focusing function is given to the telescopic optical systems.

The portable optical device may further comprise a rotary wheel rotatably supported by the inner frame, and a movement-conversion mechanism, which converts a rotational movement of the rotary wheel into a focusing movement of a part of the pair of telescopic optical systems, being provided between the rotary wheel and the part of telescopic optical systems.

The rotary wheel may comprise a rotary wheel cylinder, in which a photographing optical system is housed.

The photographing optical system can be mounted in a lens barrel provided in the rotary wheel cylinder, and a movement-conversion mechanism, which converts a rotational movement of the rotary wheel cylinder into a focusing movement of the lens barrel to focus the photographing optical system, can be provided between the rotary wheel cylinder and the lens barrel.

Optionally, the central portion is provided with an approximately U-shaped recess in which a tubular assembly composed of the rotary wheel cylinder and the lens barrel is housed.

### BRIEF DESCRIPTION OF THE DRAWINGS

The objects and advantages of the present invention will be better understood from the following description, with reference to the accompanying drawings in which:

FIG. 1 is an elevational view of an embodiment of the present invention, showing a state in which an optical stem mount plate, a control circuit board, and a power-source circuit board of a binocular telescope with a photographing function are not assembled yet to an inner frame;

FIG. 2 is an elevational view showing a state in which the optical-system mount plate, the control circuit board, and the power-source circuit board are assembled to the inner frame;

FIG. 3 is a plan view showing the inner frame;

FIG. 4 is a bottom view showing the inner frame;

FIG. 5 is a plan view of the optical-system mount plate;

FIG. 6 is a plan view showing a pair of telescopic optical systems mounted on the optical-system mount plate;

FIG. 7 is a plan view showing mount plates on which the erecting prism systems and ocular lens systems contained in a pair of telescopic optical systems are mounted;

FIG. 8 is an elevational view observed along line VIII-VIII of FIG. 7;

FIG. 9 is a longitudinal sectional view along line IX-IX of FIG. 2; and

FIG. 10 is a front view showing an annular member engaged with helicoids formed on an outer surface of a rotary wheel cylinder.

### DESCRIPTION OF THE PREFERRED EMBODIMENTS

The present invention will be described below with reference to the embodiment shown in the drawings. Note that, in the embodiment, the portable optical device is a binocular telescope with a photographing function.

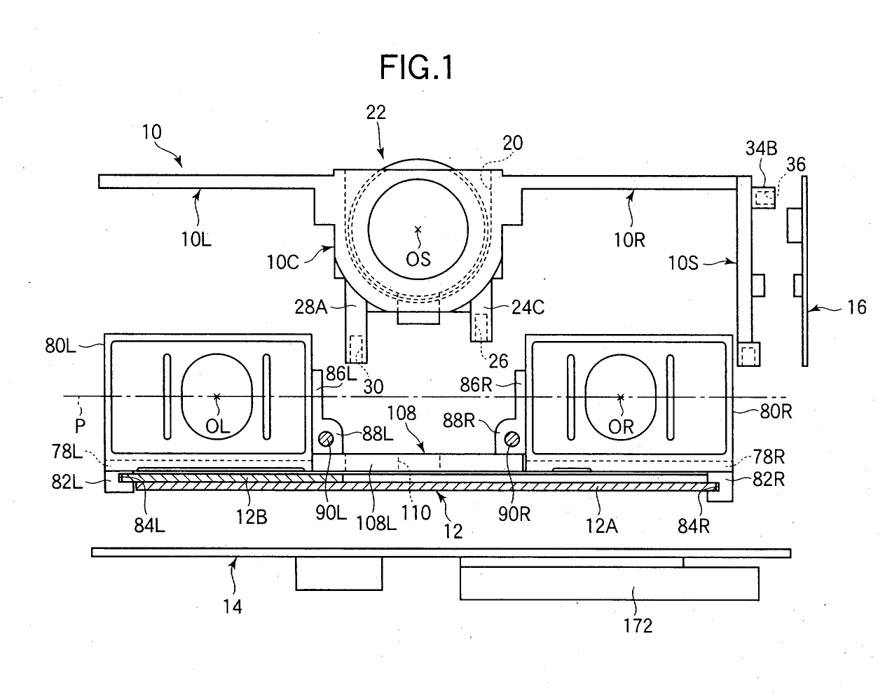

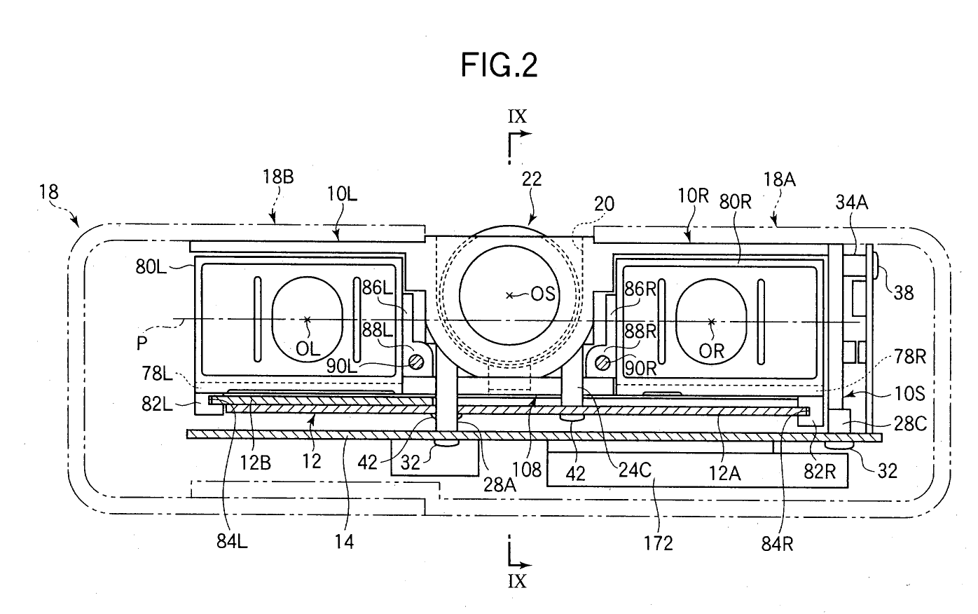

With reference to FIGS. 1 and 2, the binocular telescope has an inner frame 10, in which an optical-system mount plate 12, a control circuit board 14, and a power-source circuit board 16 are directly attached.

In an assembly process of the binocular telescope, the optical-system mount plate 12, the control circuit board 14, the power-source circuit board 16, and the other parts or units (a tubular assembly 22, for example) are attached to the inner frame 10, and the assembled structure is then housed in a casing 18 of the binocular telescope. In FIG. 2, a transverse sectional shape of the casing 18 is indicated by chain double-dashed lines. Namely, the casing 18 is box-like.

The casing 18 is composed of a main casing section 18A and a movable casing section 18B. The movable casing section 18B is slidably engaged with the main casing section 18A such that the movable casing section 18B can be moved relative to the main casing section 18A. Namely, the movable casing section 18B is movable between a retracted position shown in FIG. 2, and a maximum-extended position in which the movable casing section 18B is pulled out from the retracted position.

A suitable friction force acts on the sliding surfaces of both the casing sections 18A and 18B, and thus a certain extension or contraction force must be exerted on the movable casing section 18B before the movable casing section 18B can be extended from or contracted onto the main casing section 18A. Thus, it is possible for the movable casing section 18B to hold or stay still at an optical position between the fully retracted position (FIG. 2) and the maximum-extended position, due to the suitable friction force acting on the sliding surface of both the casing sections 18A and 18B.

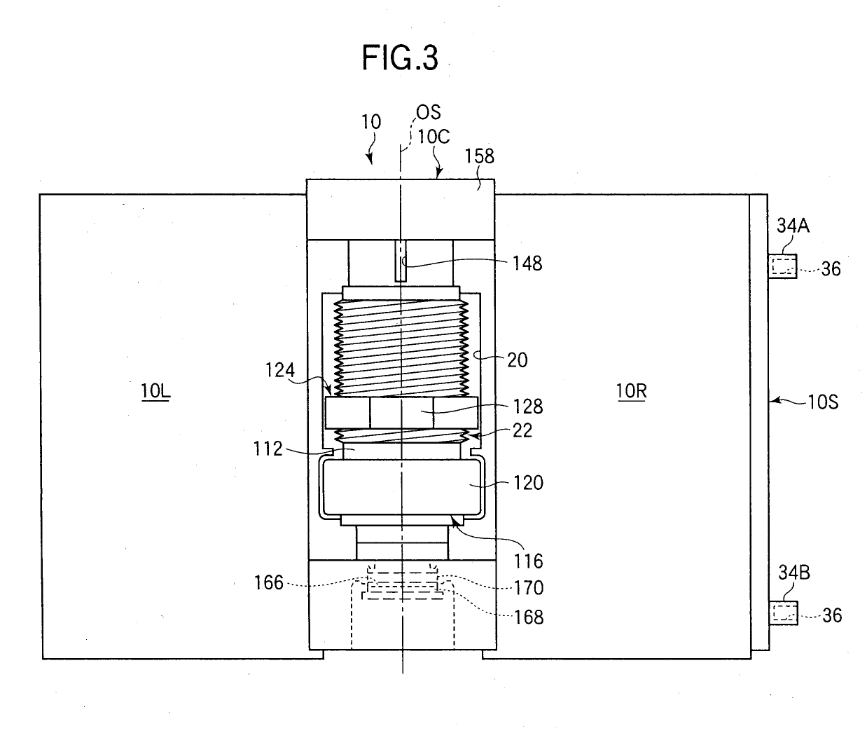

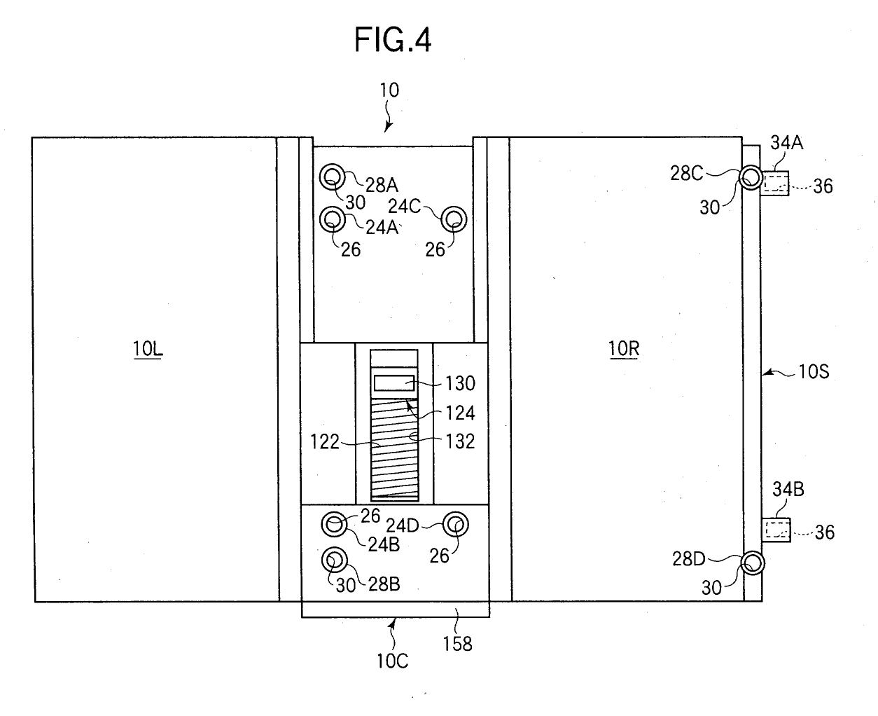

FIG. 3 is a plan view showing the inner frame 10, and FIG. 4 is a bottom view showing the inner frame 10.

The inner frame 10 has a central portion 10C, a right wing portion 10R extending from the central portion 10C rightward, a vertical wall 10S extending from a right periphery of the right wing portion 10R downward (i.e., toward the bottom of the inner frame 10), and a left wing portion 10L extending from the central portion 10C leftward. The right wing portion 10R and the left wing portion 10L are integrally connected to the central portion 10C. The vertical wall 10S is integrally connected to and substantially perpendicular to the right wing portion 10R. The inner frame 10 is made of appropriate material such as a lightweight alloy and hard synthetic resin. As understood from FIGS. 1, 2, and 3, the central portion 10C has a recess 20 which has an approximately U-shaped sectional area, and a tubular assembly 22 is provided in the recess 20.

As shown in FIG. 4, four pillar elements 24A, 24B, 24C, and 24D are integrally formed on a bottom surface of the central portion 10C, and are extend by the same length downward or in the thickness direction of the optical-system mount plate 12 and the control circuit board 14, as shown in FIG. 1. A screw hole 26 is formed in each of the end portions of the pillar elements 24A, 24B, 24C, and 24D. The pillar elements 24A and 24B are aligned along the longitudinal direction of the central portion 10C, and similarly, the pillar elements 24C and 24D are aligned along the same longitudinal direction. The pillar elements 24A, 24B, 24C, and 24D are used for supporting or suspending the optical-system mount plate 12.

Further, two pillar elements 28A and 28B are integrally formed on the bottom surface of the central portion 10C, and extend downward or in the thickness direction of the optical-system mount plate 12 and the control circuit board 14, by the same length. The pillar elements 28A and 28B are disposed adjacent to the pillar elements 24A and 24B, and aligned along the longitudinal direction of the central portion 10C. The pillar elements 28A and 28B are arranged closer to the outside periphery of the inner frame in comparison with the pillar elements 24A and 24B. The pillar elements 28A and 28B are longer than the pillar elements 24A and 24B, and are provided outside the optical-system mount plate 12. Thus, when the inner frame 10, the optical-system mount plate 12, and the control circuit board 14 are assembled as shown in FIG. 2, the end portions of the pillar elements 28A and 28B abut on the control circuit board 14 which is positioned opposite to the inner frame 10 with respect to the optical-system mount plate 12.

Furthermore, two pillar elements 28C and 28D are integrally formed on a lower edge of the vertical wall 10S, and extend downward, by the same length. The end surfaces of the pillar elements 28C and 28D are positioned at the same plane defined by the end surfaces of the pillar elements 28A and 28B. Thus, when the inner frame 10, the optical-system mount plate 12, and the control circuit board 14 are assembled as shown in FIG. 2, the end portions of the pillar elements 28C and 28D abut on the control circuit board 14.

A screw hole 30 is formed in each of the end portions of the pillar elements 28A, 28B, 28C, and 28D. Screw insert holes are formed in the portions of the control circuit board 14 corresponding to the pillar elements 28A, 28B, 28C, and 28D. As shown in FIG. 2, screws 32 are inserted in the screw insert holes and threaded in the screw holes 30, the control circuit board 14 is suspended or supported by the inner frame 10, and the optical-system mount plate 12 and the control circuit board 14 are connected to the right and left wing portions 10R and 10L in parallel to each other.

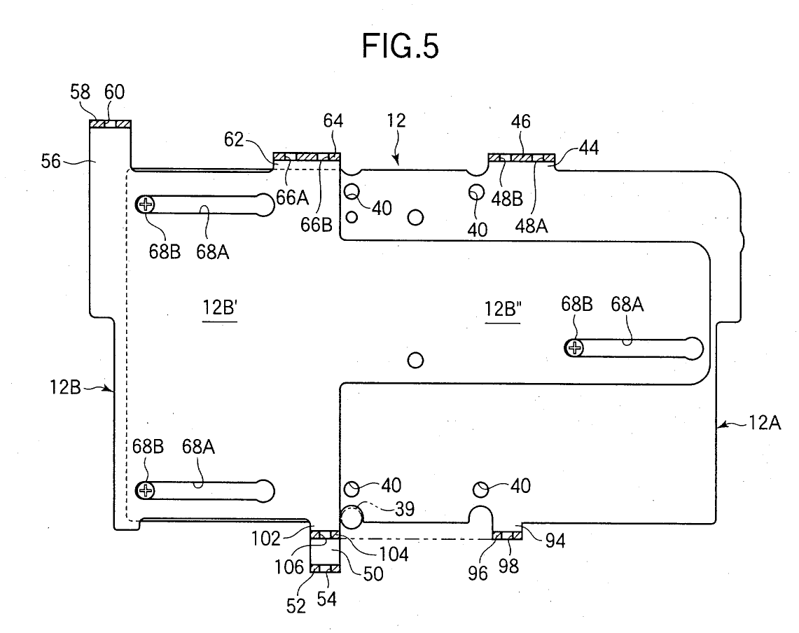

Note that, if the optical-system mount plate 12 is expanded as shown by the phantom line in FIG. 5, the pillar element 28B penetrates the optical-system mount plate 12 through a hole 39. Due to this, the tubular assembly 22 is firmly and stably connected to the optical-system mount plate 12.

As understood from FIGS. 1 through 4, short shaft 34A and 34B are integrally formed on the vertical wall 10S of the inner frame 10, and project by the same length from end portions of the upper edge of the vertical wall 10S. The short shaft 34A and 34B are aligned in the longitudinal direction of the central portion 10C, and are used for supporting the power-source circuit board 16. Namely, a screw hole 36 is formed in each of the end surfaces of the short shafts 34A and 34B, screw insert holes are formed in the portions of the power-source circuit board 16 corresponding to the short shafts 34A and 34B. As shown in FIG. 2, screws 38 are inserted in the screw insert holes and threaded in the screw holes 36, the power-source circuit board 16 is attached to a side surface of the vertical wall 10S.

As shown in FIG. 5, the optical-system mount plate 12 is composed of a rectangular plate 12A and a slide plate 12B slidably disposed on the rectangular plate 12A. The slide plate 12B has a rectangular portion 12B′, having approximately the same breadth as the rectangular plate 12A, and an extending portion 12B″, integrally connected to and extending rightward (in FIG. 5) from the rectangular portion 12B′. Four screw insert holes 40 are formed in the rectangular plate 12A, and are disposed at positions corresponding to the pillar elements 24A, 24B, 24C, and 24D. Namely, as shown in FIG. 2, the screws 42 are inserted in the screw insert holes 40 and threaded in the screw holes 26, the optical-system mount plate 12 is suspended and supported by the central portion 10C through the pillar elements 24A, 24B, 24C, and 24D.

The rectangular plate 12A is fixed to the main casing section 18A. For this fixation, a projecting portion 44 is extended from an upper periphery (in FIG. 5) of the rectangular plate 12A, and an upright fragment 46 is formed on the projecting portion 46 by bending it. In FIG. 5, the upright fragment 46 is indicated as a sectional view, and two holes 48A and 48B are formed in the upright fragment 46. Further, another projecting portion 50 is extended from a lower periphery (in FIG. 5) of the rectangular plate 12A and an upright fragment 52 is formed on the projecting portion 50 by bending it. The upright fragment 52 is also indicated as a sectional view, and a hole 54 is formed in the upright fragment 52.

Thus, screws (not shown) are inserted in the holes 48A and 54 of the upright fragments 46 and 52 and threaded in the main casing section 18A, so that the rectangular plate 12A is fixed to the main casing section 18A. Note that the other hole 48B of the upright fragment 46 is used for another object as described later.

The slide plate 12B is fixed to the movable casing section 18B. To achieve this, a projecting portion 56 is extended from a left-upper corner (in FIG. 5) of the rectangular portion 12B′ of the slide plate 12B, and an upright fragment 58 is formed on the projecting portion 56 by bending it. In FIG. 5, the upright fragment 58 is indicated as a sectional view, and a hole 60 is formed in the upright fragment 58. Further, another projecting portion 62 is extended from an upper periphery (in FIG. 5) of the rectangular portion 12B′ of the slide plate 12B, and an upright fragment 64 is formed on the projecting portion 62 by bending it. The upright fragment 64 is also indicated as a sectional view, and holes 66A and 66B are formed in the upright fragment 64.

Thus, screws (not shown) are inserted in the holes 60 and 66A of the upright fragments 58 and 64 and threaded in the movable casing section 18B, so that the slide plate 12B is fixed to the movable casing section 16B. Note that the other hole 66B of the upright fragment 64 is used for another object as described later.

Two guide slots 68A are formed in the rectangular portion 12B′ of the slide plate 12B, and another guide slot 68A is formed in the extending portion 12B″. The three guide slots 68A are parallel to each other, and extend in the right and left directions (in FIG. 5) by the same length. Guide pins 68B fixed on the rectangular plate 12A are slidably engaged in the guide slots 68A. The length of each of the guide slots 68A corresponds to a movable distance of the movable casing section 18B relative to the main casing section 18A, i.e., the distance between the retracted position of the movable casing section 18B (FIG. 2) and the maximum-extended position of the movable casing section 18B. Thus, when the movable casing section 18B is moved in the right or left direction relative to the main casing section 18A, the slide plate 12B is also moved relative to the rectangular plate 12A.

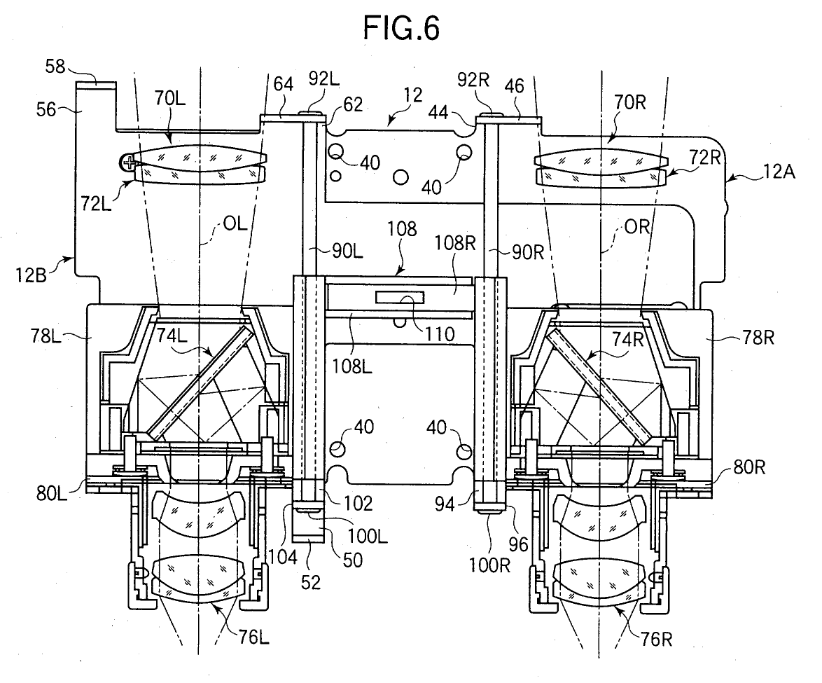

As shown in FIG. 6, the optical-system mount plate 12 is used for mounting a pair of telescopic optical systems 70R and 70L, which have a symmetrical structure and form the binoculars. The telescopic optical system 70R is a right telescopic optical system for the right eye of the user. The telescopic optical system 70R is mounted on the rectangular plate 12A, and contains an objective lens system 72R, an erecting prism system 74R, and an ocular lens system 76R. The telescopic optical system 70L is a left telescopic optical system for the left eye of a user. The telescopic optical system 70L is mounted on the rectangular portion 12B′ of the slide plate 12B, and contains an objective lens system 72L, an erecting prism system 74L, and an ocular lens system 76L. As understood from the above description, when the movable casing section 18B is moved relative to the main casing section 18A, the slide plate 12B is also moved relative to the rectangular plate 12A, so that the distance between the optical axes of the pair of telescopic optical systems 70R and 70L, i.e., interpupillary distance, is adjusted.

Note that for simplicity of explanation, in the following description, front and back are respectively defined as a side of the objective lens system and a side of the ocular lens system, relative to the pair of telescopic optical systems 70R and 70L.

The objective lens system 72R of the right telescopic optical system 70R is fixed on the rectangular plate 12A, and the erecting prism system 74R and the ocular lens system 76R can be moved back and forth with respect to the objective lens system 72R, so that the right telescopic optical system 70R can be focused. Similarly, the objective lens system 72L of the left telescopic optical system 70L is fixed on the rectangular portion 12B′ of the slide plate 12B, and the erecting prism system 74L and the ocular lens system 76L can be moved back and forth with respect to the objective lens system 72L, so that the left telescopic optical system 70L can be focused.

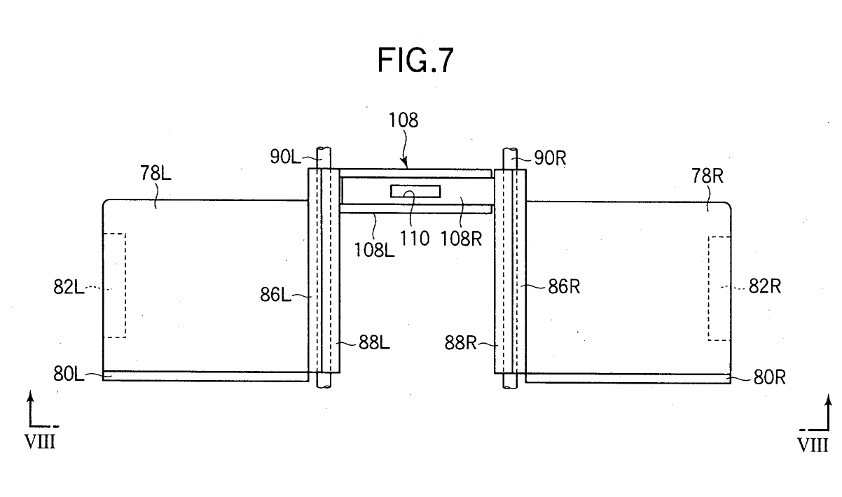

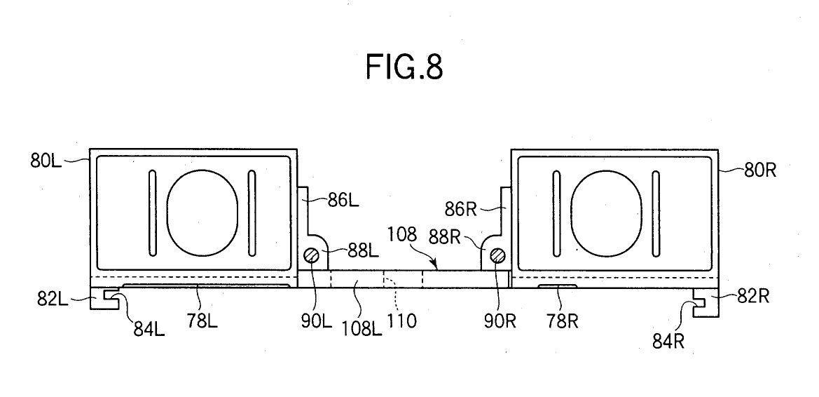

A right mount plate 78R and a left mount plate 78L, indicated in FIG. 7, are provided for focusing the pair of telescopic optical systems 70R and 70L as described above. The right mount plate 78R is disposed on the rectangular plate 12A to be movable back and forth, and as shown in FIG. 6, the erecting prism system 74R of the right telescopic optical system 70R is mounted on the right mount plate 78R. As shown in FIGS. 7 and 8, an upright plate 80R is provided along a rear periphery of the right mount plate 78R. The right ocular lens system 76R is attached to the upright plate 80R, as shown in FIG. 6.

Similarly, a left mount plate 78L is disposed on the slide plate 12B to be movable back and forth. Further, as shown in FIG. 6, the erecting prism system 74L of the left telescopic optical system 70L is mounted on the left mount plate 78L. As shown in FIGS. 6 and 7, an upright plate 80L is provided along a rear periphery of the left mount plate 70L. The left ocular lens system 76L is attached to the upright plate 80L.

As shown in FIGS. 7 and 8, the right mount plate 78R is provided with a guide shoe 82R secured to the underside thereof in the vicinity of the right side edge thereof. The guide shoe 82R is formed with a groove 84R, which slidably receives a right side edge of the rectangular plate 12A, as shown in FIGS. 1 and 2. Also, the right mount plate 78R has a side wall 86R provided along a left side edge thereof, and a lower portion of the side wall 86R is formed as a swollen portion 88R having a through bore for slidably receiving a guide rod 90R.

As shown in FIG. 6, the guide rod 90R extends in the back and forth directions of the rectangular plate 12A, and the front end thereof is securely supported by the rectangular plate 12A. Namely, a female thread hole is formed in the front end of the guide rod 90R, and a screw 92R (FIG. 6) is inserted in the hole 48B (FIG. 5) of the upright fragment 46 and threaded in the female thread hole, so that the front end of the guide rod 90R is fixed to the rectangular plate 12A.

The rear end of the guide rod 90R is securely supported by the rectangular plate 12A in a similar way as the above. Namely, as shown in FIG. 5, a projection 94 is projected from a rear end portion of the rectangular plate 12A, and an upright fragment 96 is formed by bending the projection 94. In FIG. 5, the upright fragment 98 is indicated as a sectional view, and a hole 98 is formed in the upright fragment 96 to align with the hole 48B of the upright fragment 44. A female thread hole is formed in the rear end of the guide rod 90R, and a screw 100R (FIG. 6) is inserted in the hole 98 (FIG. 5) of the upright fragment 96 and threaded in the female thread hole, so that the rear end of the guide rod 90R is fixed to the rectangular plate 12A.

Thus, the right mount plate 78R can be moved back and forth along the guide rod 90R, so that the distances from the erecting prism system 74R and the ocular lens system 76R to the objective lens system 72R is adjusted, and thus the right telescopic optical system 70R is focused.

Similarly, as shown in FIGS. 7 and 8, the left mount plate 78L is provided with a guide shoe 82L secured to the underside thereof in the vicinity of the left side edge thereof. The guide shoe 82L is formed with a groove 84L, which slidably receives a left side edge of the slide plate 12B, as shown in FIGS. 1 and 2. Also, the left mount plate 78L has a side wall 86L provided along a right side edge thereof, and a lower portion of the side wall 86L is formed as a swollen portion 88L having a through bore for slidably receiving a guide rod 90L.

As shown in FIG. 6, the guide rod 90L extends in the back and forth directions of the slide plate 12B, and the front end thereof is securely supported by the rectangular portion 12B′ of the slide plate 12B. Namely, a female thread hole is formed in the front end of the guide rod 90L, and a screw 92L (FIG. 6) is inserted in the hole 66B (FIG. 5) of the upright fragment 62 and threaded in the female thread hole, so that the front end of the guide rod 90L is fixed to the rectangular portion 12B′.

The rear end of the guide rod 90L is securely supported by the rectangular portion 12B′ of the slide plate 12B in a similar way as the above. Namely, as shown in FIG. 5, a projection 102 is projected from a rear end portion of the rectangular portion 12B′, and an upright fragment 104 is formed by bending the projection 102. In FIG. 5, the upright fragment 104 is indicated as a sectional view, and a hole 106 is formed in the upright fragment 104 to align with the hole 66B of the upright fragment 62. A female thread hole is formed in the rear end of the guide rod 90L, and a screw 100L (FIG. 6) is inserted in the hole 106 (FIG. 5) of the upright fragment 104 and threaded in the female thread hole, so that the rear end of the guide rod 90L is fixed to the rectangular portion 12B′.

Thus, the left mount plate 78L can be moved back and forth along the guide rod 90L, so that the distances from the erecting prism system 74L and the ocular lens system 76L to the objective lens system 72L are adjusted, and thus the left telescopic optical system 70L is focused.

In order to simultaneously move the right and left mount plates 78R and 78L along the guide rods 90R and 90L such that a distance between the right and left mount plates 78R and 78L is variable, the mount plates 78R and 78L are interconnected to each other by an expandable coupler 108.

In particular, as shown in FIGS. 6 and 7, the expandable coupler 108 includes a rectangular lumber-like member 108R, and a forked member 108L in which the lumber-like member 108R is slidably received. The lumber-like member 108R is securely attached to the underside of the swollen portion 88R of the side wall 86R at the forward end thereof, and the forked member 108L is securely attached to the underside of the swollen portion 88L of the side wall 86L at the forward end thereof. Both members 108R and 108L have a length which is greater than the distance of movement of the movable casing section 18B, between its retracted position (FIG. 2) and its maximum extended position. Namely, even though the movable casing section 18B is extended from the retracted position (FIG. 2) to the maximum extended position, slidable engagement is maintained between the members 108R and 108L.

Thus, the simultaneous translational movement of both the mount plates 78R and 78L along the guide rods 90R and 90L can be assured at all times, even if the movable casing section 18B is set to any extended position relative to the main casing section 18A.

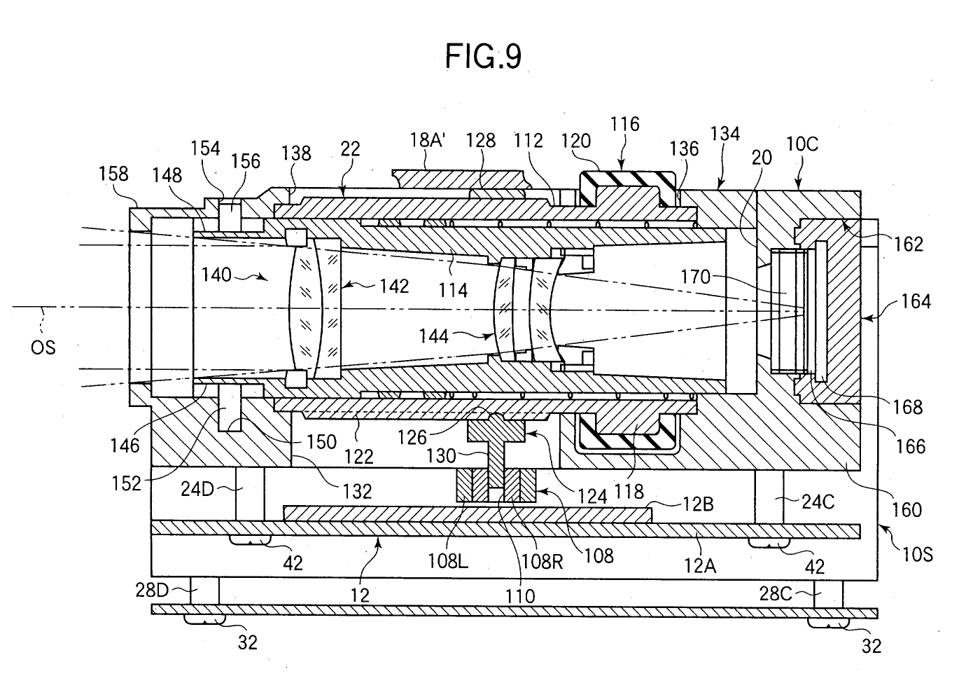

As described above, the recess 20 having an approximately U-shaped section is formed in the central portion 10C of the inner frame 10, and the tubular assembly 22 is provided in the recess 20. As shown in FIG. 9, the tubular assembly 22 has a rotary wheel cylinder 112 and a lens barrel 114 coaxially disposed in the rotary wheel cylinder 112. As will be described later, the rotary wheel cylinder 112 is rotatably supported in the recess 20, and the lens barrel 114 can be moved along the central axis thereof while the lens barrel 114 is kept still so as not to rotate about the central axis.

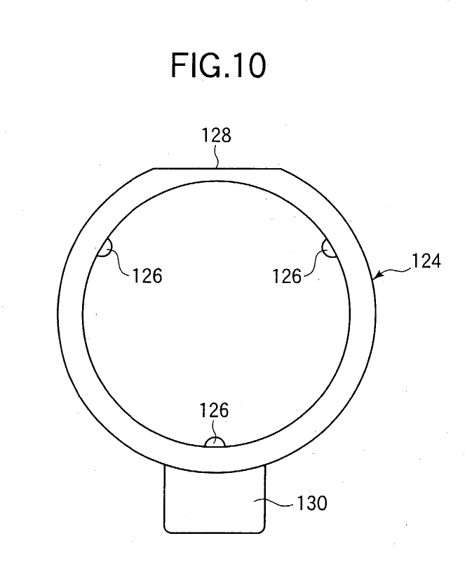

A rotary wheel 116 is provided on the rotary wheel cylinder 112. The rotary wheel 116 has an annular projection 118 formed on an outer surface of the rotary wheel cylinder 112, and an annular rubber cover 120 attached on the annular projection 118. Helicoids 122 are formed on an outer surface of the rotary wheel cylinder 112, and an annular member 124 is threadingly fit on the helicoids 122. Namely, as shown in FIG. 10, three projections 126, engaged with the helicoids 122 of the rotary wheel cylinder 112, are formed on an inner wall of the annular member 124, and disposed at a constant interval.

Further, as shown in FIG. 10, a flat surface 128 is formed on an outer periphery of the annular member 124, and a tongue 130 is projected from the annular member 124. The flat surface 128 and the tongue 130 are positioned at opposite sides of the annular member 124. As shown in FIG. 4, a rectangular opening 132 is formed in the bottom of the central portion 10C of the inner frame 10. When the tubular assembly 22 is housed in the recess 20 of the central portion 10C, the tongue 130 of the annular member 124 penetrates the rectangular opening 132.

In an assembling process of the binocular telescope, when the tubular assembly 22 is housed in the recess 20 of the central portion 10C, the recess 20 is partially covered with a curved plate 134, which is curved to fit with an outer surface of the rotary wheel cylinder 112, and a part of the rotary wheel 116 and parts of the helicoids 122 are exposed. Namely, the curved plate 134 has two rectangular openings 136 and 138, so that the part of the rotary wheel 116 is exposed from the rectangular opening 136, and parts of the helicoids 122 are exposed from the rectangular opening 138.

Thus, when the tubular assembly 22 is housed in the recess 20 of the central portion 10C and the recess 20 is covered with the curved plate 134, the annular member 124 is positioned such that the flat surface 128 is exposed from the rectangular opening 138, and the rotary wheel cylinder 112 is rotatable in the recess 20, as shown in FIG. 9. Note that the curved plate 134 is fixed on the central portion 10C with a screw and so on (not shown).

As described above, in the assembling process, the optical-system mount plate 12, the control circuit board 14, the power-source circuit board 16, and the other parts or units are assembled to the inner frame 10, so that this assembled structure is housed in the casing 18 of the binocular telescope. In this condition, although part of the rotary wheel 116 is exposed through the opening 138, the rectangular opening 138 is covered by part of the top wall 18A′ of the main casing section 18A, and the flat surface 128 is slidably engaged with an inner wall of the top wall 18A′ Therefore, when a user rotates the rotary wheel cylinder 112 by contacting the exposed portion of the rotary wheel 116 with a finger, for example, the annular member 124 is moved along the central axis of the rotary wheel cylinder 112 due to the threading contact with the helicoids 122, since the annular member 124 is prevented from rotating due to the engagement of the flat surface 128 and the top wall 18A′. The moving direction depends on the rotational direction of the rotary wheel cylinder 112.

As shown in FIG. 9, a photographing optical system 140 is provided in the lens barrel 114, and has a first lens group 142 and a second lens group 144. A pair of key ways 146 and 148 are formed in the front end portions of the lens barrel 114. Each of the key ways 146 and 148 extends by a predetermined length from the front edge of the lens barrel 114 along the optical axis of the photographing optical system 140. A blind hole 150 is formed on a bottom of a front end portion of the U-shaped recess 20. A pin 152 is inserted in the blind hole 150, and engages with the key way 146. A through hole 154 is formed in a front end portion of the curved plate 134. A pin 156 is inserted in the through hole 154, and engages with the key way 146. Thus, the lens barrel 114 cannot rotate about the central axis thereof, but can be moved along the central axis by a distance corresponding to the length of the pair of key ways 146 and 148.

A tip portion of the central portion 10C is a sleeve 158, which is coaxial with the lens barrel 114. Namely, the central axis of the sleeve 158 is coincident with the optical axis of the photographing optical system 140 housed in the lens barrel 114, and functions as a light entrance mouth to the photographing optical system 140.

A stepped circular opening 162 is formed in a rear end portion 160 of the central portion 10C. The central axis of the stepped circular opening 162 is coincident with the optical axis of the photographing optical system 140 in the lens barrel 114. An imaging-device holing member 164 is fit in the stepped circular opening 162, and aligned with the photographing optical system 140. The imaging-device holding member 164 holds an assembly composed of a solid-state imaging device such as a CCD 166, and a CCD circuit board 168 controlling an operation of the CCD 166. Further, the imaging-device holding member 164 has an optical low-pass filter 170, which is disposed at a predetermined distance from a light-receiving surface of the CCD 166. Thus, the binocular telescope of this embodiment has the same photographing function as a digital camera, so that an object image obtained by the photographing optical system 140 is formed on the light-receiving surface of the CCD 166 through the optical low-pass filter 170.

In FIGS. 1 and 2, the optical axis of the photographing optical system 140 is indicated by the reference OS, and the optical axes of the right and left telescopic optical systems 70R and 70L are indicated by references OR and OL. The optical axes OR and OL are parallel to each other, and to the optical axis OS of the photographing optical system 140. As shown in FIG. 2, the optical axes OR and OL define a plane P which is parallel to the optical axis OS of the photographing optical system 140. The right and left telescopic optical systems 70R and 70L can be moved parallel to the plane P, so that the distance between the optical axes OR and OL, i.e., interpupillary distance, can be adjusted.

When the inner frame 10 and the optical-system mount plate 12 are assembled, a tip portion of the tongue 130 of the annular member 124 is fit in an opening 110 formed in the lumber-like member 108R as shown in FIG. 9. Therefore, as described above, when the rotary wheel cylinder 112 is rotated through the rotary wheel 116, so that the annular member 124 is moved along the central axis of the rotary wheel cylinder 112, the right mount plate 78R and the left mount plate 78L are integrally moved with the movement of the annular member 124. Namely, due to the rotation of the rotary wheel 116, the distance from the ocular lens systems 76R and 76L to the objective lens systems 72R and 72L is adjusted, so that the pair of telescopic optical systems 70R and 70L are focused.

In this embodiment, the pair of telescopic optical systems 70R and 70L are designed, for example, in such a manner that, when the distance from each of the objective lens systems 72R and 72L to each of the ocular lens systems 76R and 76L is the shortest, the pair of telescopic optical systems 70R and 70L focus on an object located at a distance between 40 meters ahead of the binocular telescope and infinity, and when observing an object between 2 meters and 40 meters ahead of the binocular telescope; the ocular lens systems 76R and 76L are separated from the objective lens systems 72R and 72L so as to focus on the object. Namely, when the ocular lens systems 76R and 76L are separated from the objective lens systems 72R and 72L by the maximum distance, the pair of telescopic optical systems 70R and 70L focus on an object located at a distance approximately 2 meters ahead of the binocular telescope.

Thus, in the binocular telescope, a section of a movement-conversion mechanism for converting a rotational movement of the rotary wheel cylinder 112 into a focusing movement of the pair of telescopic optical systems 70R and 70L is provided on a side of the inner frame 10, and another section of the movement-conversion mechanism is provided on a side of the optical-system mount plate 12. And when the optical-system mount plate 12 is connected to the inner frame 10, the sections are engaged with each other, so that the movement-conversion mechanism functions.

When the photographing optical system 140 is constructed to be able to perform pan-focus photography in which the photographing optical system 140 focuses an object including a near object, which is situated at a predetermined distance ahead of the binocular telescope, and an object at infinity, and a photographing operation is performed only in the pan-focus photography, a focusing mechanism does not need to be mounted in the lens barrel 114. In the embodiment, however, since the binocular telescope is required to photograph a near object, which is situated less than 2 meters ahead of the binocular telescope similarly to a usual camera, the lens barrel 114 needs to be provided with a focusing mechanism.

Therefore, female helicoids are formed on an inner wall of the rotary wheel cylinder 112, and male helicoids, that engage with the female helicoids of the rotary wheel cylinder 112, are formed on an outer wall of the lens barrel 114. When the rotary wheel cylinder 112 is rotated, the lens barrel 114 is moved along the optical axis of the photographing optical system 140, since the lens barrel 114 is prevented from rotating due to the engagement of the key ways 146 and 148 and the pins 152 and 156. The moving direction of the lens barrel 114 depends upon the rotational direction of the rotary wheel cylinder 112. Thus, the helicoids formed on the inner wall of the rotary wheel cylinder 112 and the outer wall of the lens barrel 114 form a movement-conversion mechanism that converts a rotational movement of the rotary wheel cylinder 112 into a linear movement or focusing movement of the lens barrel 114.

Helicoids 122 formed on the outer wall of the rotary wheel cylinder 112 and the helicoids formed on the inner wall of the rotary wheel cylinder 112 are inclined in the opposite direction to each other so that, when the rotary wheel cylinder 112 is rotated in such a manner that the ocular lens systems 76R and 76L are separated from the objective lens systems 72R and 72L, the lens barrel 114 is moved to separate from the CCD 166. Due to this, an image of a near object can be focused on the light-receiving surface of the CCD 166. The pitch of the helicoids 122 and the pitch of the helicoids of the inner wall are different from each other in accordance with the optical characteristics of the pair of telescopic optical systems 70R and 70L and the photographing optical system 140.

As shown in FIGS. 1 and 2, a CF-card holder 172 is attached to an under surface of the control circuit board 14. A CF-card or memory card can be detachably mounted on the CF-card holder 172 through an opening (not shown) formed in the bottom of the main casing section 18A. Image data obtained through the CCD 166 is stored in the CF-card memory 172. Note that various kinds of electronic parts including a processor, a memory, a semiconductor, a transistor, and so on, are mounted on the upper and lower surfaces of the control circuit board 14, which are not shown in FIGS. 1 and 2.

On the other hand, various kinds of electronic parts are mounted on the power-source circuit board 16, so that the power-source circuit board 16 is relatively heavy as known. Thus, a large weight acts on an outside portion of the main casing section 18A, so that the binocular telescope may become uncomfortable to handle. Accordingly, in the embodiment, an inner space of an outside portion of the movable casing section 18B is used as a battery chamber in which batteries are housed, so that the weight balance of the whole of the binocular telescope is improved.

In the embodiment, the photographing optical system 140 is disposed in the rotary wheel cylinder 112 so that the binocular telescope with a photographing function is constituted compactly. However, the photographing optical system 140 need not be housed in the rotary wheel cylinder 112, and in this case, the rotary wheel cylinder 112 can be a slender solid shaft.

As described above, in the optical device, parts having a relatively large size, i.e., the optical-system mount plate, the control circuit board, and the power-source circuit board are disposed between the inner frame and the optical-system mount plate. Therefore, the other parts or units can be directly attached to the inner frame as needed. For example, in the embodiment described above, parts that relate to the adjustment of the interpupillary distance of the telescopic optical systems and focusing control, and that do not need to be attached to the optical-system mount plate, can be attached to the inner frame without interfering with the control circuit board. Thus, the attaching accuracies of the parts or units, which should be attached to the inner frame, are determined on the basis of the inner frame, so that the attaching accuracies are improved. Further, since many of the parts or units are assembled in the inner frame as one body, the whole structure of the device is strengthened.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-102396 (filed on Apr. 4, 2002) which is expressly incorporated herein, by reference, in its entirety.

1. A portable optical device comprising:
an optical-system mount plate;
a control circuit board; and
an inner frame that has a first support mechanism for supporting said optical-system mount plate, and a second support mechanism for supporting said control circuit board, said first and second support mechanisms being constructed in such a manner that said optical-system mount plate is disposed between said inner frame and said control circuit board.

2. A device according to claim 1, wherein said first support mechanism has first pillar elements that are formed on said inner frame and extend in the thickness direction of said optical-system mount plate and said control circuit board, and said second support mechanism has second pillar elements that are formed on said inner frame and extend in the thickness direction of said optical-system mount plate and said control circuit board, said optical-system mount plate and said control circuit board being connected through said first and second support mechanisms to said inner frame so as to be parallel to each other.

3. A device according to claim 2, wherein said first pillar elements are formed with first screw holes, said optical-system mount plate is formed with first insert holes corresponding to said first screw holes, end portions of said second pillar elements, in which second screw holes are formed, abut on said control circuit board which is positioned opposite to said inner frame with respect to said optical-system mount plate, said control circuit board is formed with second insert holes corresponding to said second screw holes, and first screws are inserted in said first insert holes and threaded in said first screw holes and second screws are inserted in said second insert holes and threaded in said second screw holes, so that said optical-system mount plate and said control circuit board are connected to said inner frame.

4. A device according to claim 2, wherein said inner frame has a central portion, a wing portion extending from said central portion along said optical-system mount plate, and a vertical wall extending from a periphery of said wing portion so that said vertical wall is substantially perpendicular to said wing portion, said first pillar elements extending from said central portion, at least one of said second pillar elements extending from said central portion, and the other of said second pillar elements extending from said vertical wall.

5. A device according to claim 2, wherein said second pillar elements are provided outside said optical-system mount plate.

6. A device according to claim 2, wherein at least one of said second pillar elements penetrates through said optical-system mount plate.

7. A device according to claim 1, further comprising a pair of telescopic optical systems that is mounted on said optical-system mount plate, so that said device functions as binoculars.

8. A device according to claim 7, wherein said optical-system mount plate has two plate members, one of said telescopic optical systems being mounted on one of said plate members while another of said telescopic optical systems is mounted on another of said plate members, said plate members being moved relative to each other so that a distance between the optical axes of said telescopic optical systems is adjustable.

9. A device according to claim 7, wherein a part of each of said telescopic optical systems is movable relative to the other part of each of said telescopic optical systems, so that a focusing function is given to said telescopic optical systems.

10. A device according to claim 9, further comprising a rotary wheel rotatably supported by said inner frame, and a movement-conversion mechanism, which converts a rotational movement of said rotary wheel into a focusing movement of a part of said pair of telescopic optical systems, being provided between said rotary wheel and said part of telescopic optical systems.

11. A device according to claim 10, wherein said rotary wheel comprises a rotary wheel cylinder, in which a photographing optical system is housed.

12. A device according to claim 11, wherein said photographing optical system is mounted in a lens barrel provided in said rotary wheel cylinder, and a movement-conversion mechanism, which converts a rotational movement of said rotary wheel cylinder into a focusing movement of said lens barrel to focus said photographing optical system, is provided between said rotary wheel cylinder and said lens barrel.

13. A device according to claim 12, wherein said central portion is provided with an approximately U-shaped recess in which a tubular assembly having said rotary wheel cylinder and said lens barrel is housed.
